(19) United States
(12) Patent Application Publication
(10) Pub. No.: US 2010/0097801 A1
(43) Pub. Date: Apr. 22, 2010

(54) LED LIGHT STICKS AND LAMP BARS

(75) Inventor: Jia H. Deng, Diamond Bar, CA (US)

Correspondence Address: FSP LLC, P.O. BOX 890, VANCOUVER, WA, 98666, US

(73) Assignee: DM Technology & Energy Inc., Montclair, CA (US)

(21) Appl. No.: 12/560,412

(22) Filed: Sep. 15, 2009

Related U.S. Application Data
(60) Provisional application No. 61/096,950, filed on Sep. 15, 2008.

(51) Int. Cl. F21V 1/00

(52) U.S. Cl. 362/235

(57) ABSTRACT

A light bar includes two ends separated by a long axis, and at least one LED light source at one or both ends, and no LED light sources along the long axis.

### PRIORITY

This application claims priority under 35 USC 119 to U.S. patent application Ser. No. 61/096,950 filed on Monday, Sep. 15, 2008, which is presently pending and which is incorporated herein by reference in its entirety.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIGS. 1-3 show embodiments of an LED light source with LEDs at two ends of a long axis, and a reflecting surface along a long axis.

FIG. 4 shows an embodiment of an LED light source with an LED at one end of a long axis, and a reflecting surface along a long axis.

FIG. 5 shows an embodiment of a long axis with a reflecting surface and a transparent surface.

FIG. 6 shows an embodiment of an LED light source with LEDs at two ends of a long flexible axis.

FIG. 7 shows an embodiment of retaining hardware as it relates to the LED source and to the radiator.

FIG. 8 shows an exploded view of an embodiment of an LED light source that uses a square cross-section long axis.

FIG. 9 shows an embodiment of retaining hardware 112 as it relates to the LED source and to the radiator.

FIG. 10 shows an embodiment of a square-cross sectional long axis element.

FIGS. 11-14 are illustrations of embodiments of a dual light bars.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

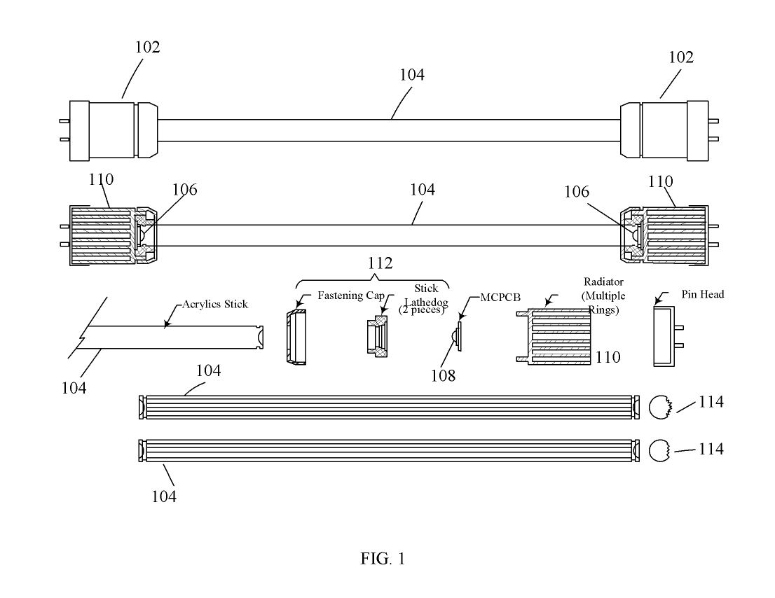

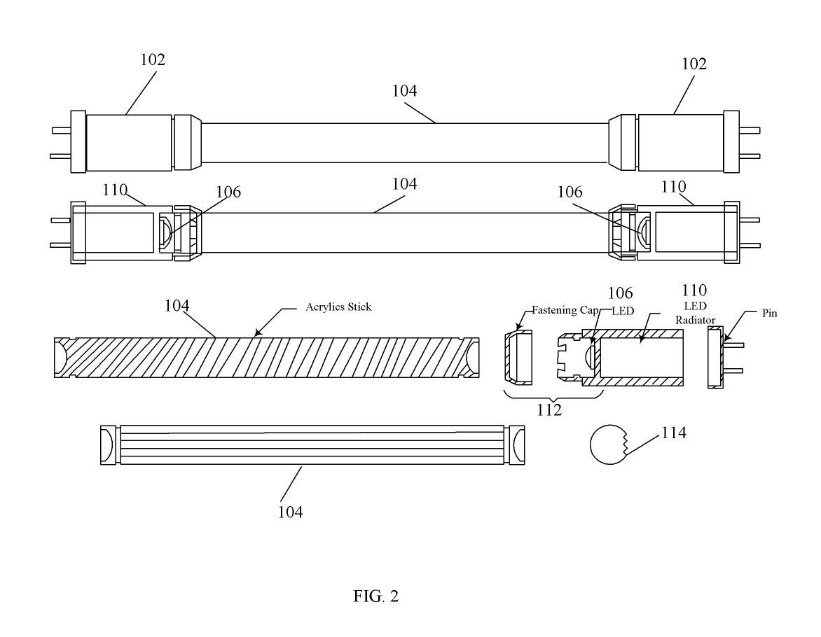

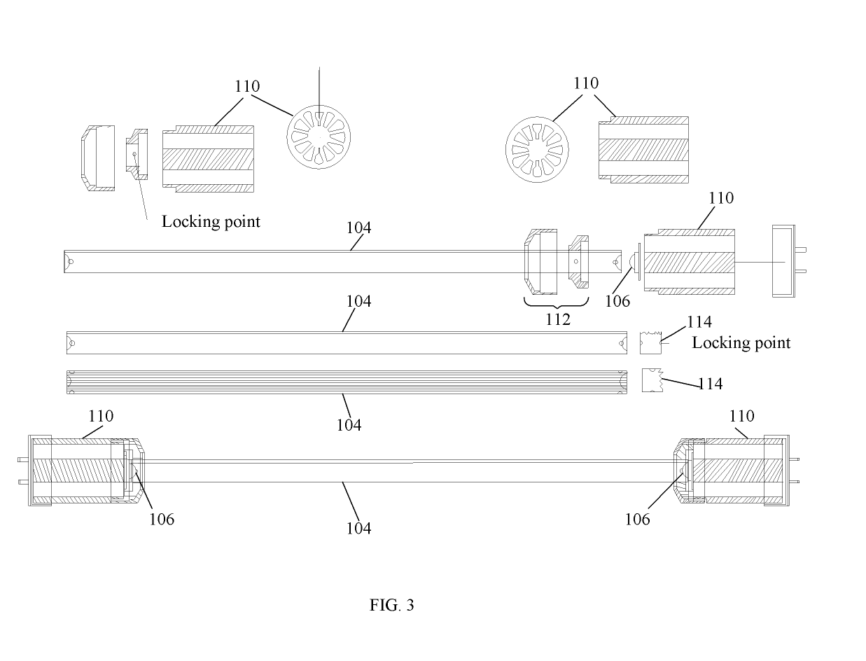

FIGS. 1-3 show embodiments of an LED light source with LEDs at two ends of a long axis, and a reflecting surface along a long axis. Embodiments of such an LED lighting apparatus may provide applications such as replacements for fluorescent bar lamps and may have pin heads making them compatible for such applications.

The long axis 104 separating the ends 102 may be substantially circular, elliptical, square, rectangular, or some other cross-section (see for example 114). The long axis may comprise an acrylic stick. The ends 102 may comprise radiators 110 to dissipate heat away from the LED light sources 106 (see also 108). The ends 102 may comprise fastening hardware 112 to retain and couple the axis 104, the LEDs 106, the radiators 110, and the pin heads.

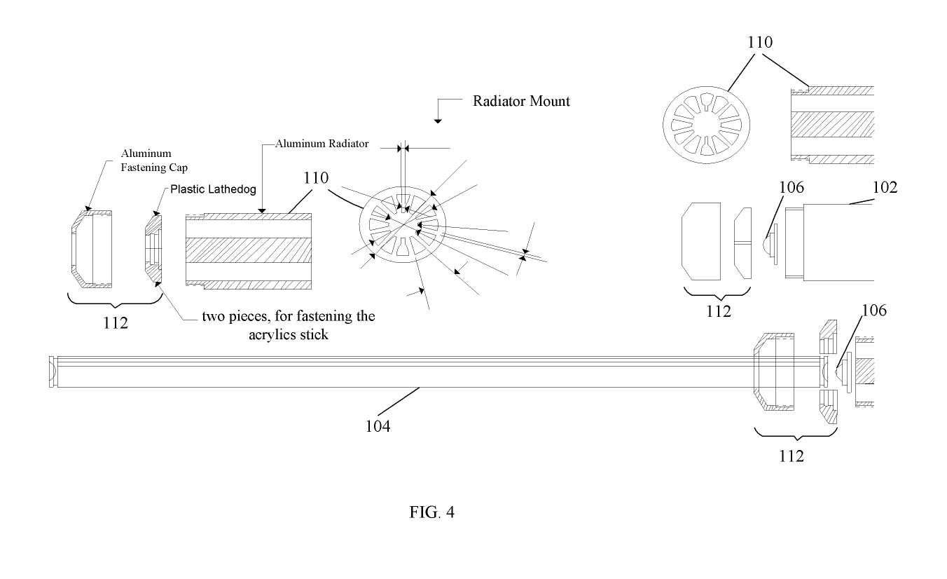

FIG. 4 shows an embodiment of an LED light source with an LED at one end of a long axis, and a reflecting surface along a long axis. Embodiments of such an LED lighting apparatus may provide applications such as replacements for fluorescent bar lamps and may have pin heads making them compatible for such applications.

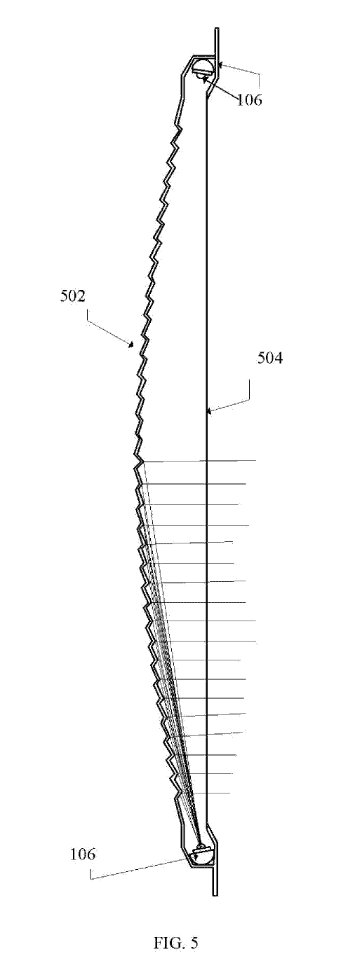

FIG. 5 shows an embodiment of a long axis with a reflecting surface 502 and a transparent surface 504. A similar embodiment may leave off the transparent surface 504. In other words, the long axis 104 coupling the distal ends 102 maybe a partial enclosure or a full enclosure. The long axis 104 may comprise one or more reflecting surfaces, or one or more diffusers, or a combination of reflectors and diffusers. The long axis 104 may comprise acrylic or some other plastic, glass like materials known in the art for such applications, or other materials.

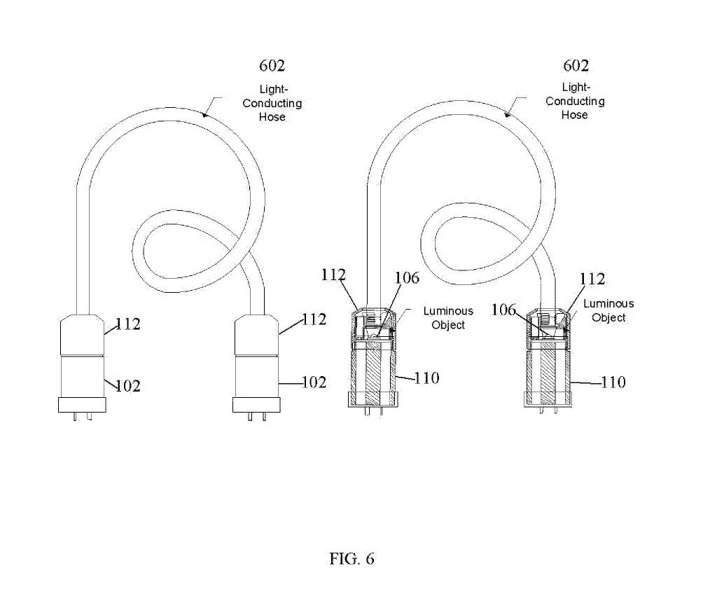

FIG. 6 shows an embodiment of an LED light source with LEDs at two ends of a long, flexible axis. The flexibility of the long axis may prove useful in certain situations, such as lighting situations where special shapes are needed.

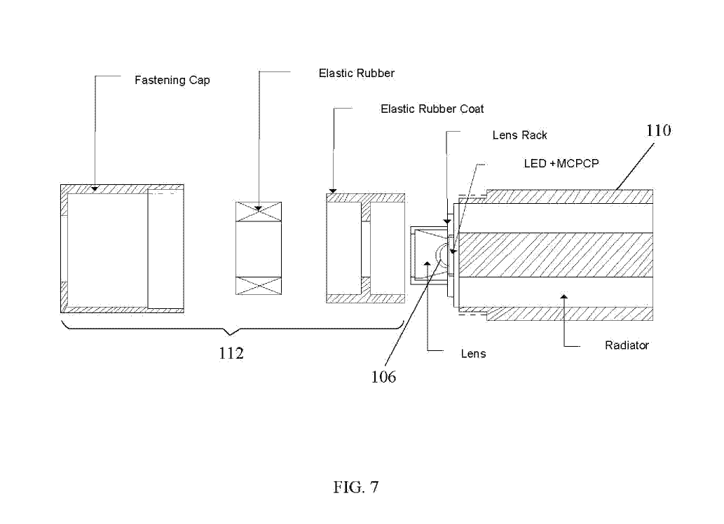

FIG. 7 shows an embodiment of retaining hardware 112 as it relates to the LED source 106 and to the radiator 110.

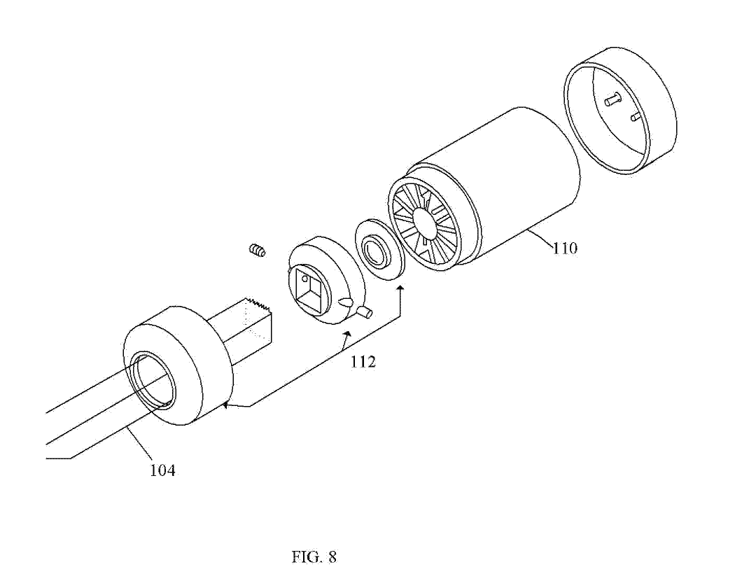

FIG. 8 shows an exploded view of an embodiment of an LED light source that uses a square cross-section long axis 104.

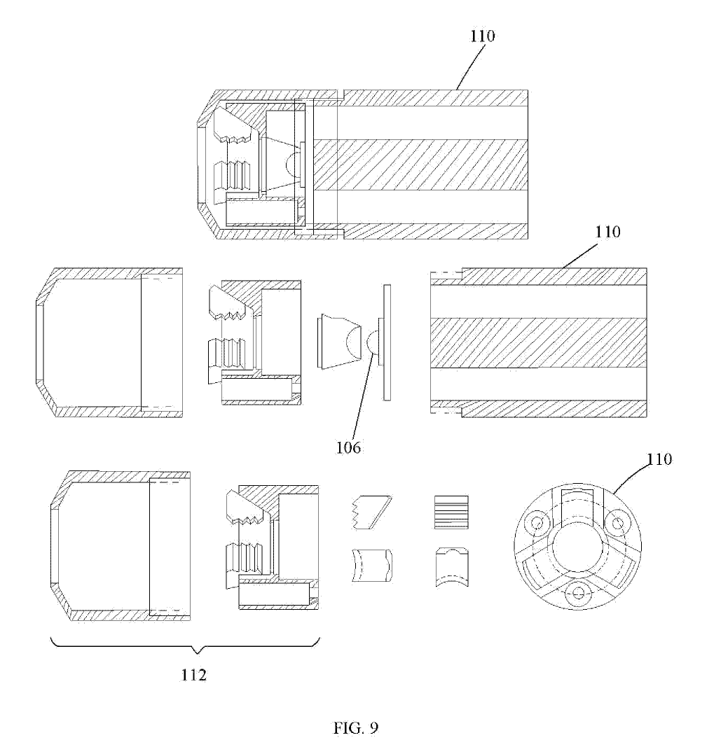

FIG. 9 shows an embodiment of retaining hardware 112 as it relates to the LED source 106 and to the radiator 110.

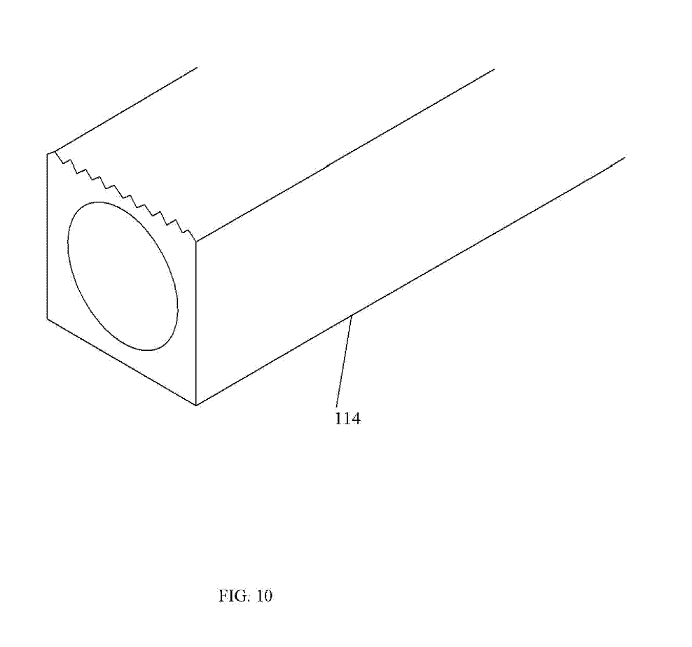

FIG. 10 shows an embodiment of a square-cross sectional long axis element 104.

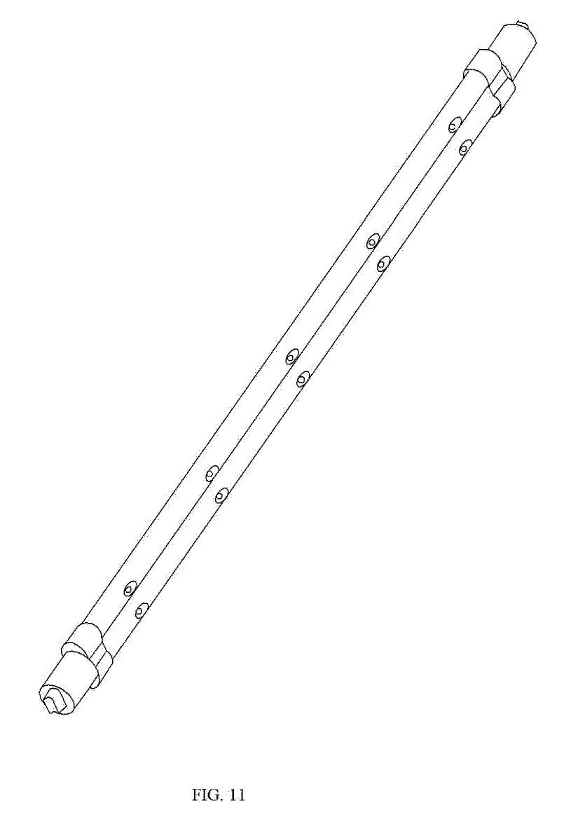

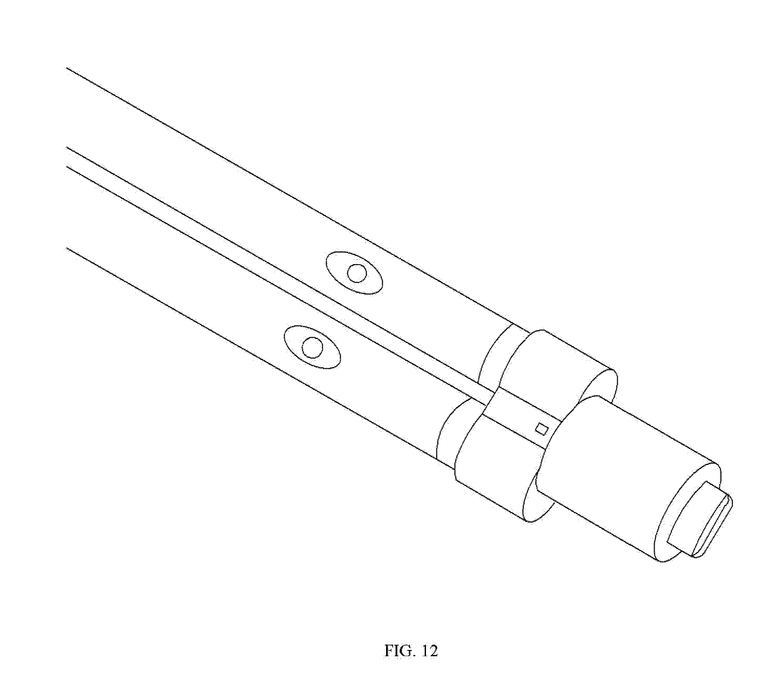

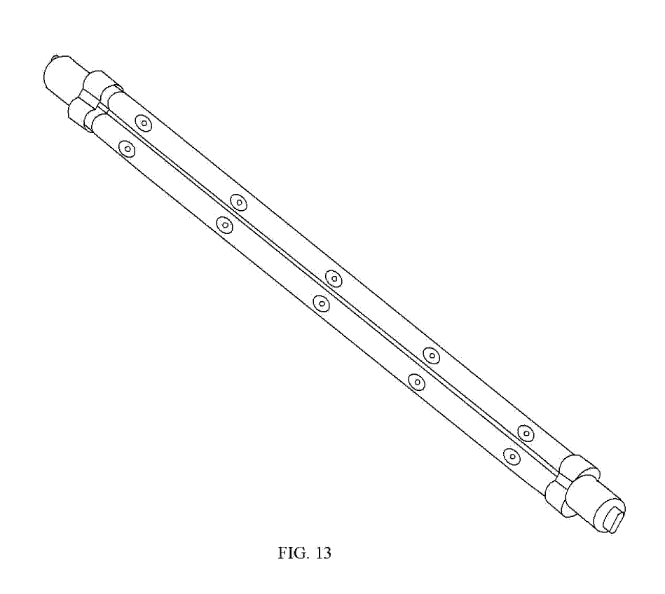

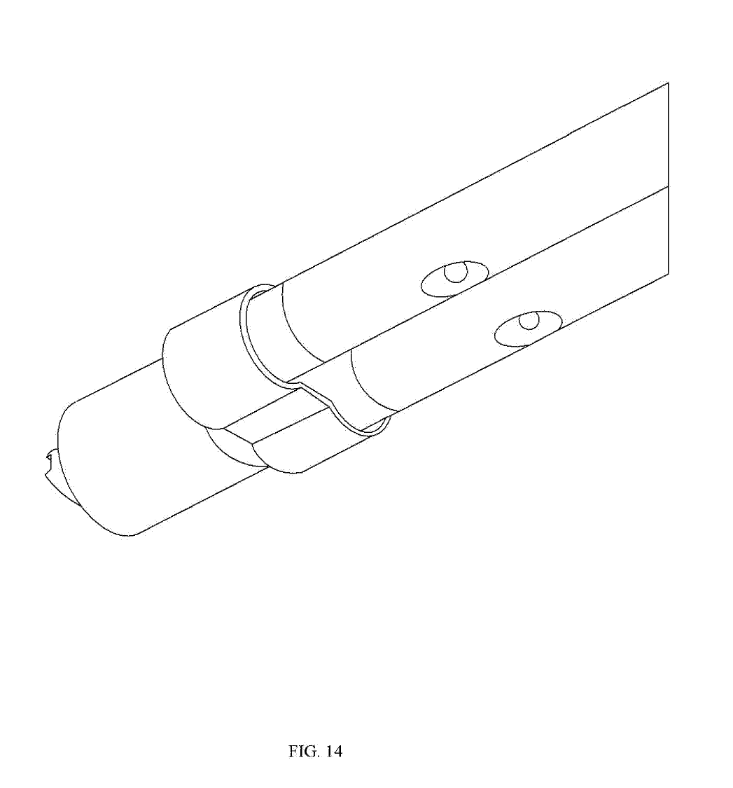

FIGS. 11-14 are illustrations of embodiments of a dual light bars. Each light bar may be designed and operated in accordance with the principles set for in co-pending U.S. patent application Ser. No. 11/897,243, which is incorporated herein by reference in its entirety.

What is claimed is:

1. A light bar comprising:
two ends separated by a long axis; and
at least one LED light source at one or both ends, and no LED light sources along the long axis.

2. The light bar of claim 1, further comprising:
the long axis has a reflective portion.

3. The light bar of claim 1, further comprising:
a pin head that is compatible with the socket for a fluorescent light bar.

4. The light bar of claim 1, further comprising:
the long axis is flexible.
